(19) United States
(12) Patent Application Publication
(10) Pub. No.: US 2011/0053502 A1
(43) Pub. Date: Mar. 3, 2011

(54) System for Automatic Detection of Smart Cards

(75) Inventors: Norbert Miller, Monchengladbach (DE); Wolfgang Flügge, Korschenbroich (DE)

(73) Assignee: SCHEIDT & BACHMANN GMBH, Monchengladbach (DE)

(21) Appl. No.: 12/862,938

(22) Filed: Aug. 25, 2010

(30) Foreign Application Priority Data
Aug. 25, 2009 (EP) 09 010 838.2

(51) Int. Cl. H04B 5/00

(52) U.S. Cl. 455/41.1

(57) ABSTRACT

A system for automatic detection of smart cards, particularly of electronic tickets, has a control computer and a detection device. The detection device has a communication interface for the communicating coupling with a smart card. A communication link is established between the control computer and the detection device that is designed in a wireless fashion.

### BACKGROUND OF THE INVENTION

The present invention relates to a system for automatic detection of smart cards, in particular electronic tickets, and to the use of the system. The invention also relates to a ticket detection system for automatic detection of electronic tickets.

Systems for automatic detection of smart cards are known. They are used for instance for verifying the validity of smart card-based electronic tickets. In public transportation, the fare to be paid is hereby calculated. For this purpose, the smart card is inserted in the opening of a writing and reading device. A contact field arranged on the surface of the smart card is contacted by spring contacts of the reading and writing device. A communication link is established, during which existing data are read from the smart card and are transferred to a control computer which is in a bidirectional communication link with the reading and writing device. The control computer processes the data read from the smart card and produces new data which are transmitted to the reading and writing device, which device immediately writes these data into the smart card through the communication link to the smart card. From the processed data, information on the use of the smart card in the public means of transport is received, and this information serves for billing the fare.

Especially in public transport, the installation of a system for automatic detection of smart cards is complex and expensive. On the one side, the system must be capable of detecting a high number of smart cards within a short time, e.g. during rush hours of public transport. On the other hand, the system must be incorporated in vehicles of public transport, thus requiring complicated and expensive modifications in the vehicles.

One possibility of easy incorporation of the system for automatic detection of smart cards in a public transport vehicle is preparing the vehicle for the incorporation of the system for automatic detection of smart cards already at the time of its construction. Another way is to incorporate the system in the first place. This requires the provision of corresponding transmission lines and interfaces in the vehicle. To enable continuous use of the system for automatic detection of smart cards in a public transport vehicle, all the public transport vehicles must be equipped with the system for automatic detection of smart cards. For that purpose, the vehicles can be completely replaced on the one side. This first option is usually dismissed for reasons of cost, because such vehicles are extremely expensive to purchase and they are normally used for a very long time. On the other side, existing vehicles can be subsequently modified, which requires much time and material. This latter option is dismissed, because the services cannot be interrupted. Modifying existing vehicles further requires money and time, which frequently is a reason why the introduction of a system for automatic detection of smart cards is rejected. This prevents such systems from being widely used.

### SUMMARY OF THE INVENTION

It is the object of the present invention to further develop a system for automatic detection of smart cards to that effect that the system can be installed easily and operates reliably.

This object is solved in that a system for automatic detection of smart cards, in particular electronic tickets, is proposed, the system comprising a control computer and a detection device, the detection device comprising a communication interface for a communicating coupling with a smart card, wherein a communication link'is established between the control computer and the detection device, said communication link is in a wireless communication link.

The invention provides for the possibility to arrange the detection device independently of an existing installation and of a control computer with only minimal fitting work. Moreover, the arrangement of the detection device can be subsequently modified at discretion and as needed, thus achieving high flexibility. The detection device can be a writing device and/or reading device, but it can also be constituted by only a reading device or only a writing device. It is particularly beneficial, if the writing and reading device has an integral design. The reading device comprises the communication interface for the communicating coupling with the smart card. This can be achieved by a wire-bound communication interface, the detection device including for example a contact spring panel that can be electrically coupled with a contact field of a smart card. Thus the communicating coupling between the detection device and the smart card can be adjusted.

Of course, it can be provided that the reading device at least partly supplies energy to the smart card. This enables a smart card that does not have its own energy supply to be coupled for communication. The smart card can be designed for example as a transponder or the like. In particular, it can be designed as a passive transponder, i.e. it does not have its own energy supply. In the latter case, the smart card will get energy for its intended operation from the detection device as soon as a corresponding coupling has been effectuated. The smart card can be designed for example as a substantially flat, rectangular card, e.g. of plastic, paper or textile material or the like. The smart card is frequently also referred to as chip card or integrated circuit card (ICC). The smart card is characterized in that it includes a hardware circuit, a memory unit and a computer unit. The units are preferably arranged in an integrated semiconductor chip. The dimensions of the smart card can be according to the industrial standard ISO 7816. Particularly simple smart card designs merely have a memory unit. In this case, they are also referred to as memory chip cards. The interaction between the detection unit and the smart card can be provided according to the PC-SC standard. Such smart cards are known for example as SIM cards for mobile phones or the like.

The control computer is in communication with the detection device. The detection device can transfer the data read from the smart card to the control computer. In this way, information is available for use at the control computer. The control computer can be arranged near the detection device, but also remotely from the detection device. The distance between the control computer and the detection device is limited by the reach of the wireless communication link. The wireless communication link can for example be a radio communication link, an ultra sound communication link, an infrared communication link or the like.

The system for automatic detection of smart cards is not only limited to use in public transport, but it can also be generally used in systems for admission or access control. Accordingly, the system may be used for example in sporting facilities, leisure facilities like zoos, libraries or the like.

Preferably, the detection device is arranged in a housing that allows the detection device to be installed in a very versatile manner at a desired location. On the other hand, the control computer can be arranged at a suitable remote location. It can be incorporated for example in a different device or the like. It can be provided that the control computer in a vehicle of public transport is arranged behind a lining of the vehicle, the lining being designed in such a way that it does not considerably impede the wireless communication with the detection device. This can be achieved for example by the selection of suitable materials for the lining or also by providing communication windows or the like. This arrangement of the control computer further allows the control computer to be coupled to an existing energy supply for its intended operation.

The invention also allows in an easy manner to provide several detection units which communicate with the control computer. This is advantageous especially for public areas in which a high number of smart cards must be detected within a predetermined time range. The system according to the invention thus allows adapting the capacity of detecting automatic smart cards as desired and according to the needs, depending on the capacity of the detection device. This can be accomplished by adding or removing detection devices. Moreover, it is also possible to exchange detection devices in an easy manner, since their mounting only requires little effort. Due to the wireless design of the communication link, complicated mounting and integration of the device are no longer required.

It turned out to be particularly beneficial if the detection device comprises its own energy supply, device because said energy supply enables the detection device to be connected to or disconnected from the system for automatic detection of smart cards substantially without complicated wiring. Accordingly, in the case or retrofitting or also at the exchange of the detection device, the corresponding efforts are limited to the mechanical fixing or removal of the detection device. The energy supply device can be formed for instance by a battery, an accumulator, a fuel cell, a solar cell, combinations thereof or the like.

Furthermore, it turned out to be beneficial if the wireless communication link is a bidirectional design, because the detection device can thus be provided with data from the control computer. It can be provided for instance that data from the control computer that are to be written onto the smart card are transferred to the detection device. Furthermore, it is possible to check whether the detection device is suitable or authorized for operation in connection with the system for automatic detection of smart cards. This option allows improving the system security. This avoids that a detection device is added to or removed from the system in an unauthorized manner. Furthermore, the bidirectional communication link enables programming of the detection device through the control computer. It is possible for example to transfer program parts or updates necessary for the operation of the detection device from the control computer to the detection device to thus allow or improve its intended operation. If the detection device comprises a data base, updating may be provided also for this data base.

It is particularly advantageous if the wireless communication link is a near field radio connection. Thus a plurality of applications can be covered, a simple implementation being possible due to the relatively low requirements concerning electromagnetic compatibility and disturbances. Moreover, it is possible to fall back on known communication protocols like Bluetooth or the like, whereby easy implementation is achieved.

The invention further proposes that the system includes a main level computer which is in bidirectional communication with the control computer. The main level computer can be provided for controlling the control computer or also a plurality of control computers. It is further possible to concentrate the detection of smart cards to a central location, namely the main level computer, in order to obtain further information based thereupon. It can be provided for example, that that the main level computer serves to automatic billing or charging of fares for using a public means of transport. To this end, the main level computer can automatically generate transactions like debiting user accounts or the like. It is also possible with the main level computer to establish a security function concerning the data of the control computer. The control computer can communicate with the main level computer either permanently or also temporarily. If the control computer is installed for instance in a vehicle, it can be provided that a communication with the main level computer is established at the time at which the vehicle assumes a predetermined parking place. This option does not require maintaining a permanent communication with the control computer, which on the other hand would also require an expensive permanent communication link. It can be provided for example that the main level computer is arranged in the area of a vehicle depot of public transport. It is particularly beneficial if the communication link between the main level computer and the control computer is also wireless, at least partly, so that a communication link can be established automatically without requiring manual activities. The control computer can be designed for processing data transferred by the detection device and obtained from the smart card. This avoids the necessity of transferring smart card-related data completely to the main level computer. Communication time and cost can be reduced. At the same time, this design allows the use of a particularly simple detection device that is needed only for reading or writing data from or onto the smart card. Thus particularly inexpensive reading devices can be used. Furthermore, this design does not require a permanent, but merely a temporary communication link with the main level computer.

But the invention can also provide at least one detection device for processing data collected in a smart card. This reduces complexity of communication between the detection unit and the control computer. Thus the communication capacity between the control computer and said one or more detection units can be reduced on the one side while on the other side energy required for the wireless communication can be saved on part of the detection unit. It is possible for example to reduce a detection unit's own energy source.

Furthermore, it turned out to be an advantage if the communication interface of at least one detection device is designed for wireless communication with the smart cards. This further improves reliability of system operation, since interference-prone contact-based communication links can be avoided. It is also possible to improve the user-friendly handling by merely requiring the smart-card to be brought into the detection range of the detection unit, without any direct contact between the detection device and the smart card. This makes handling easier for the user and additionally improves reliability of detection.

Furthermore, the use of the system of the invention as a ticket detection system using electronic tickets, particularly smart card-based electronic tickets, is proposed. This allows simple implementation, particularly by modifying existing means of public transport, precisely in ticket detection systems. The system of the invention thus becomes particularly interesting for use in public transport like busses, trains or the like. Because retrofitting of the system is particularly easy, the system can be installed in corresponding vehicles at low expense. It is thus possible to equip public means of transport with the system at low cost and with only little time for mounting.

The invention further proposes a ticket detection system for automatic detection of electronic tickets, the ticket detection system including a control computer and a ticket detection device, the ticket detection device including a communication interface for coupling with an electronic ticket for communication, a communication link being established between the control computer and the ticket detection device, the communication link being designed in a wireless fashion.

The ticket detection device can be formed by one of the above-described detection devices. Also the control computer can be one as described above. Of course, the ticket detection system can also be combined with the features of the above-described system for the detection of smart cards. In particular, the embodiments of the system can also be applied to the ticket detection system.

The ticket detection system of the invention is characterized in that it can be easily implemented or subsequently mounted particularly in means of public transport. This is achieved by designing the communication link between the control computer and the ticket detection device in a wireless fashion. Accordingly, it can be provided that the control computer is arranged in a vehicle of public transport, the control computer being in communication with one or more ticket detection devices also arranged in the vehicle of public transport, via the wireless communication link. The ticket detection devices can be preferably arranged in the vehicle's entry and/or exit area.

It can be provided for example that the ticket detection device is arranged in the entrance door area of the vehicle. Particularly advantageously, several ticket detection devices are arranged in the door area, so that several electronic tickets can be detected or read at the same time. This allows achieving a high detection rate of electronic tickets especially in the rush hours. Of course, the electronic ticket can be in the form of a smart card, but it can also be merely a memory card, a passive transponder, an infrared memory card, a paper ticket carrying a bar code or the like. In the latter two cases, the ticket detection device can be constituted by merely a reading unit that reads for example an identification code or the like from the electronic ticket and supplies it to further processing. Thus the ticket detection system can be used in a particularly versatile manner. The ticket detection system can also be designed for operation with different electronic tickets.

According to a further advantageous feature of the invention, the detection device represents on its part a bidirectional communication interface, wherein data can be transferred between the control computer and the smart card without further data processing in the detection device.

According to a further advantageous feature of the invention, the wireless communication link is in a bidirectional communication link.

According to a further advantageous feature of the invention, the wireless communication link is a near field radio communication.

According to a further advantageous feature of the invention, a main level computer is in bidirectional communication with the control computer.

According to a further advantageous feature of the invention, the control computer is arranged for processing smart card-related data transferred by the detection device.

According to a further advantageous feature of the invention, a detection device is arranged for processing data read from a smart card.

According to a further advantageous feature of the invention, at least one detection device includes an internal processing unit that comprises a memory interconnected in a logic circuit.

According to a further advantageous feature of the invention, the communication interface of at least one detection device is designed for wireless communication with the smart cards.

According to a further advantageous feature of the invention, the detection device is a writing and reading device, wherein the writing and reading device being integrally designed, wherein the energy supply being arranged internally and connected to an internal processing unit via a transmission line.

According to a further advantageous feature of the invention, a communication link between the control computer and the main level computer is established at a time at which the vehicle approaches a predetermined parking place.

According to a further feature of the invention, the detection device can be added to the system, wherein the control computer detects whether the detection device is admitted or authorized for operation with the system for automatic detection of smart cards.

### BRIEF DESCRIPTION OF THE DRAWINGS

Further features and advantages will become apparent from the following description of embodiments of the invention, wherein same components are identified by same reference numbers. Furthermore, concerning identical features and identical functions, reference is made to the description of the embodiment according to FIG. 1. The drawings are schematic drawings and merely serve for illustrating the following embodiments. In the drawings it is shown by

FIG. 1 a schematic overall view of a system for automatic detection of smart cards according to the invention;

FIG. 2 a schematic block diagram of a first arrangement of a detection device for the system according to FIG. 1;

FIG. 3 a schematic block diagram of a second arrangement of a detection device for the system according to FIG. 1.

### DESCRIPTION OF PREFERRED EMBODIMENTS

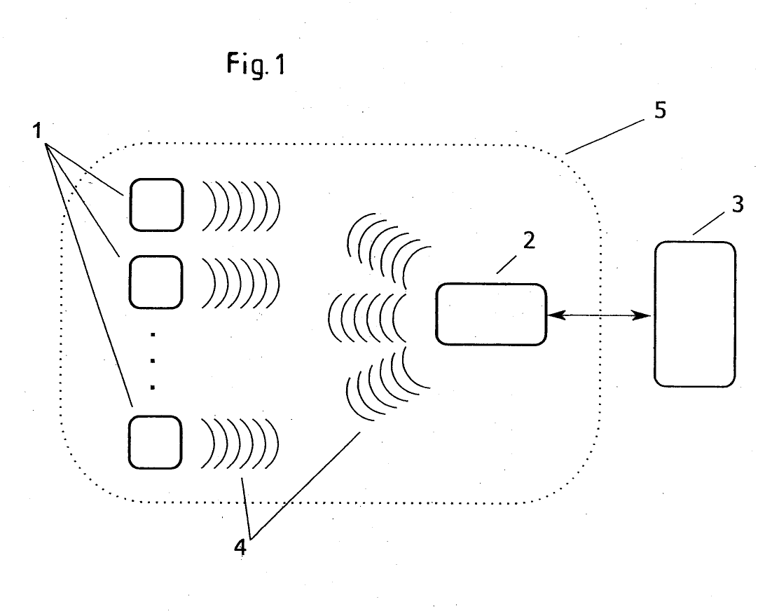

FIG. 1 shows an inventive system for automatic detection of smart cards, the system in the present case being designed as a ticket detection system for automatic detection of electronic tickets. The system comprises a local area 5 which in the present case is arranged in the interior of a vehicle of public transport (not illustrated), for example a bus or the like. In the local area 5, a control computer 2 is arranged behind a lining which is not illustrated.

The system according to this arrangement uses smart cards as electronic tickets, which are uniquely assigned to the respective user. For this reason, in the range of vehicle doors (not illustrated) several detection devices 1 are arranged which in the present case are designed as smart card writing and reading devices 1.

The smart card writing and reading device 1 is arranged for establishing a communication interface in the form of a near field communication 10 for the communicating coupling with a smart card. In this arrangement, the near field communication 10 is part of a smart card writing/reading unit 9 which is comprised in turn by the smart card writing and reading device 1.

Further, between the control computer 2 and the smart card writing and reading device 1, a wireless, bidirectional communication link is provided in the form of a near field radio communication 4. Via this near field radio communication 4, data can be exchanged between the smart card writing and reading device 1 and the control computer 2. To this end, the control computer 2 comprises transmission and receiving means (not illustrated). In the present case, the communication link is designed as near field radio communication providing a communication range of approx 50 meters within the local area 5. According to a polling protocol (not further illustrated), the control computer 2 communicates with the smart card writing and reading device 1 in an alternating fashion and/or at need.

In the present case, the control computer 2 includes a memory unit (not further illustrated) for memorizing data relevant for billing the use of the means of public transport.

In a vehicle depot of public transport vehicles, a main level computer 3 is arranged. Both the control computer 2 and the main level computer 3 have communication means which allow the control computer 2 and the main level computer 3 to communicate as soon as the public transport vehicle is within the range of the vehicle depot. A near field communication is provided also in the present case. When the control computer 2 starts to communicate with the main level computer 3, the data memorized in its memory unit are transferred to the main level computer 3. The main level computer processes the data received from the control computer 2 and prepares information relevant for billing on the basis of these data. Basing ^{.}on this information relevant for billing, the main level computer 3 establishes transactions which allow the use of the public transport means being billed to the respective user.

Moreover, the main level computer 3 is capable of transmitting information to the control computer 2. This information can comprise for instance tariff data, hot list and white list entries, action lists and the like. Moreover, the possibility exists for a data base (not illustrated) of the control computer 2 being updated by the main level computer 3.

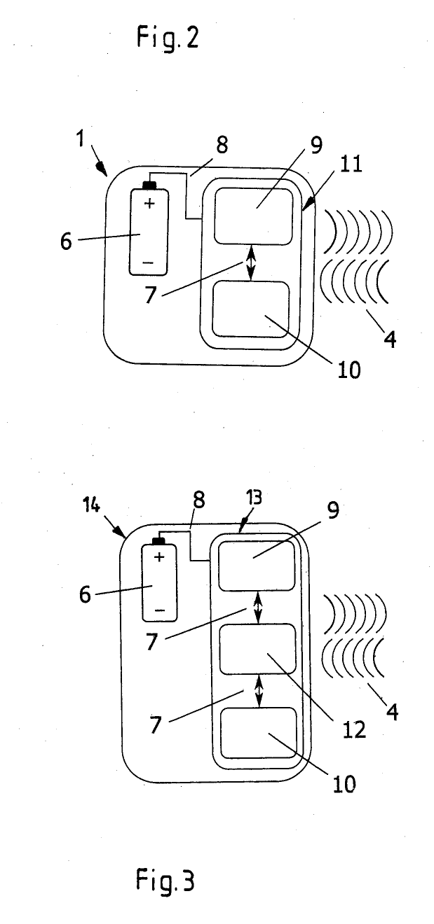

In a first embodiment of the invention, a smart card writing and reading device 1 according to FIG. 2 is used. The smart card writing and reading device 1 comprises an internal processing unit 11, which is supplied with energy from an internal, autonomous energy supply 6 via an electric supply line 8. In the present case, the energy supply 6 is constituted by an accumulator.

The internal processing unit 11 in the present embodiment includes a smart card writing/reading unit 9 which is in bidirectional communication 7 with the near field communication 10. The near field communication 10 forms the communication interface to the smart card and in the present case is designed in a wireless fashion. Via this near field communication 10, the smart card writing and reading unit 9 communicates with a smart-cart that is present within the communication range and reads its data: In addition to that, the smart card writing/reading unit 9 can write data onto the smart card.

The internal processing unit 11 further includes communication means (not further illustrated) which serve to establish a wireless near field radio communication 4 with the control computer 2.

In this embodiment, no processing of data read from a smart card takes place in the smart card writing and reading device 1. The data are rather directly transmitted without further processing to the control computer 2 for further processing, via the near field radio communication 4. As a result of the processing of the data from the control computer 2, the control computer 2 transfers new data to the internal processing unit 11, which writes these new data into the smart card that is in the communicating status, by means of the smart card writing/reading unit 9 and the near field communication 10.

In the present case, the control computer 2 memorizes the data and, if necessary, also the transaction reports that are transferred to the main level computer 3 at the next communication connection.

FIG. 3 shows an alternative embodiment of a smart card writing and reading device 14. This smart card writing and reading device 14 can be used in place of the smart card writing and reading device 1 illustrated in FIG. 1. The smart card writing and reading device 14 differs from the smart card writing and reading device 1 in that it has an internal processing unit 13 which for its part comprises a memory 12 interconnected in the logical connection 7. By means of the memory 12, it is possible for the smart card writing/reading unit 9 to memorize information required for processing the data read from a smart card and to make the processing already by the smart card writing and reading device 14 itself. Any data transfer of smart card-related data to the control computer 2 is thus unnecessary. Based on the processing of the data read from the smart card, the internal processing unit 13 generates new data that are again written onto the smart card. At the same time, a transaction report is established and transmitted to the control computer 2 via the near field radio communication 4.

This considerably reduces the amount of communication data via the near field radio communication 4, so that the control computer 2 can serve a plurality of smart card writing and reading devices 14 even with a lower communication capacity of the near field radio communication 4. Moreover, the reduced amount of communication data makes it possible to guarantee a highly fail-safe and reliable communication and also a reliable and safe operation of the system.

Also, data memorized in the memory 12 can be updated at least partially by the control computer 2 via the near field radio communication 4. Accordingly, it is possible for instance to update processing-relevant data, tariff data, hotlist and white list entries, action lists or the like in the smart card writing and reading device 14.

The invention allows the smart card writing and reading devices 1, 14 to be arranged at any place within the vehicle and also to be exchanged, if necessary. Moreover, any special wiring of the smart card writing and reading devices 1, 14 is not required, so that the installation work is minimum. Additionally, an expedient arrangement of the smart card writing and reading devices 1, 14 in the vehicle can be achieved in an easy way, for instance in the door area of the vehicle or the like.

Although the system for the automatic reading of smart cards has been described using the example of electronic tickets for a ticket detection system, the system can of course be used also in other facilities in which access control or access billing is decisive. Such facilities can be sports facilities, libraries, public events or the like, especially as also other electronically evaluable IDs such as barcode IDs, infrared IDs or the like can be used with the system according to the invention.

The embodiments illustrated in the drawings merely serve to explain the invention and are not in any way intended to be limiting the invention. Of course, features of the different embodiments can also be combined with each other, in order to adapt the invention to the respective needs.

The specification incorporates by reference the entire disclosure of European priority document 09 010 838.2 having a filing date of Aug. 25, 2009.

While specific embodiments of the invention have been shown and described in detail to illustrate the inventive principles, it will be understood that the invention may be embodied otherwise without departing from such principles.

### LIST OF REFERENCE NUMBERS

1 smart card writing/reading device

2 control computer

3 main level computer

4 near field radio communication

5 local area

6 energy supply device

7 logical connection

8 transmission line

9 smart card writing/reading unit

10 near field communication

11 internal processing unit

12 memory

13 internal processing unit

14 smart card writing-reading device

What is claimed is:

1. A system for automatic detection of a smart card, the system comprising:
a control computer;
a detection device, the detection device comprising a communication interface establishing a communicating coupling with a smart card;
a wireless communication link connecting the control computer and the detection device.

2. The system according to claim 1, wherein the smart card is an electronic ticket.

3. The system according to claim 1, wherein the detection device comprises an energy supply device of its own.

4. The system according to claim 1, wherein the wireless communication link is a bidirectional communication link.

5. The system according to claim 1, wherein the wireless communication link is a near field radio communication link.

6. The system according to claim 1, comprising a main level computer and a bidirectional communication link connecting the control computer and the main level computer.

7. The system according to claim 1, wherein the control computer processes data of the smart card which data is read and transmitted by the detection device to the control computer.

8. The system according to claim 1, wherein the detection device processes data that the detection device has read from the smart card.

9. The system according to claim 1, wherein the communication interface of the detection device provides wireless communication with the smart card.

10. The system according to claim 1, as a ticket detection system, wherein the smart card is an electronic ticket.

11. A ticket detection system for automatic detection of electronic tickets, the system comprising:
a control computer;
a ticket detection device, the ticket detection device comprising a communication interface establishing a communicating coupling with an electronic ticket;
a wireless communication link connecting the control computer and the ticket detection device.

12. The system according to claim 11, wherein the ticket detection device comprises an energy supply device of its own.

13. The system according to claim 11, wherein the wireless communication link is a bidirectional communication link.

14. The system according to claim 11, wherein the wireless communication link is a near field radio communication link.

15. The system according to claim 1, comprising a main level computer and a bidirectional communication link connecting the control computer and the main level computer.

16. The system according to claim 1, wherein the control computer processes data of the electronic ticket which data is read and transmitted by the detection device to the control computer.

17. The system according to claim 1, wherein the detection device processes data that the detection device has read from the electronic ticket.

18. The system according to claim 1, wherein the communication interface of the ticket detection device provides wireless communication with the electronic ticket.
